(19) United States
(12) Patent Application Publication
(10) Pub. No.: US 2026/0155776 A1
(43) Pub. Date: Jun. 4, 2026

(54) SOLAR ENERGY DEVICE FOR AUTOMATICALLY CONTROLLED SUN TRACKING SYSTEM

(71) Applicant: COLLECTION LIGHT ENVIRONMENT ENERGY DEVELOP LIMITED COMPANY, New Taipei (TW)

(72) Inventor: YEU-WEN CHEN, New Taipei (TW)

(21) Appl. No.: 19/316,863

(22) Filed: Sep. 2, 2025

(30) Foreign Application Priority Data
Nov. 29, 2024 (TW) 113146332

(51) Int. Cl. H02S 20/32; G05D 3/10

(52) U.S. Cl. CPC H02S 20/32; G05D 3/105

(57) ABSTRACT

A solar energy device for an automatically controlled sun tracking system comprises: a revolution component; a revolution control component provided with first and second touch switches and a revolution timer, the first and second switches are connected to first and second revolution actuators for switching a revolution forward and reverse switch electrically connected to the timer and a revolution drive motor and energizing the motor at a set time; an axial rotational component; and an axial rotation control component provided with first and second axial rotational actuation timers and an axial rotation timer, the first and second timers are connected to first and second axial rotational actuators for switching an axial rotational forward and reverse switch electrically connected to the axial rotation timer and an axial rotational drive motor and energizing the motor at a set time.

### BACKGROUND OF THE INVENTION

### Field of Invention

The invention relates to a solar energy device, more particularly to a solar energy device for an automatically controlled sun tracking system that does not require the use of special chips or sensors and is capable of tracking the sun by utilizing the revolution of the earth around the sun and the rotation of the earth itself, thereby achieving a reduction in manufacturing and maintenance costs.

### Related Art

At present, the use of power generation equipment or heating equipment that can save energy and does not emit carbon pollution to the environment is a current trend in the industry. There are conventional solar power supply devices or solar power heating devices or devices that convert light into electricity for heating through light collection, however, these devices are too expensive or have low heating efficiency, which reduces the user's desire to use them. Moreover, because the areas where sufficient sunlight can be obtained are relatively remote, there is a high demand for the configuration of devices that can convert solar energy into electricity or heat energy.

There is another conventional solar panel supporting device that utilizes two sets of drive shafts with gears on the end edges to cooperate with gear plates to rotate in one direction, and requires the use of another two sets of drive shafts with gears on the end edges to cooperate with gear plates in another direction to rotate in the other direction. The drive of the two drive shafts mainly relies on a control chip to process and track solar detection and control. The control chip needs to undergo complex software programming and testing to enable the solar panel to rotate according to the trajectory of the sun. Therefore, the installation cost of the solar panel supporting device is high, when the solar panel supporting device needs to be repaired, it is also necessary to test or replace the control chip, and even to redesign the control chip according to the trajectory of the sun. Therefore, the solar panel supporting device needs to be repaired by the original manufacturer, which makes the repair cost high.

Therefore, how to improve the drawbacks and tackle the problems mentioned above is the technical difficulty that the inventor of the invention wants to solve.

### SUMMARY OF THE INVENTION

Therefore, in order to effectively solve the above-mentioned problems, a main object of the invention is to provide a solar energy device for an automatically controlled sun tracking system that does not require the use of special chips or sensors and is capable of tracking the sun by utilizing the revolution of the earth around the sun and the rotation of the earth itself, thereby achieving a reduction in manufacturing and maintenance costs.

In order to achieve the above-mentioned object, the invention provides a solar energy device for an automatically controlled sun tracking system, which comprises: a revolution component, the revolution component is provided with two revolution rotating disks, a revolution drive shaft and a revolution drive motor, the revolution drive shaft is assembled with the revolution rotating disks and connected to the revolution drive motor; a revolution control component, the revolution control component is provided with a first positioning pin, a second positioning pin, a first touch switch, a second touch switch and a revolution timer, the first touch switch is connected to a first revolution actuator, the first revolution actuator is driven by the first positioning pin contacting the first touch switch and switches a revolution forward and reverse switch, and the second touch switch is connected to a second revolution actuator, the second revolution actuator is driven by the second positioning pin contacting the second touch switch and switches the revolution forward and reverse switch, the revolution forward and reverse switch is electrically connected to the revolution timer and the revolution drive motor, the revolution timer energizes the revolution drive motor at a set time, the revolution drive motor rotates the revolution rotating disks via the revolution drive shaft, and the revolution timer stops energizing the revolution drive motor and stops rotating the revolution rotating disks at a set time; an axial rotational component, the axial rotational component is disposed on the revolution component, and the axial rotational component is provided with two axial rotational rotating disks, an axial rotational drive shaft and an axial rotational drive motor, the axial rotational drive shaft is assembled with the axial rotational rotating disk and connected to the axial rotational drive motor; and an axial rotation control component, the axial rotation control component is provided with a first axial rotational actuation timer, a second axial rotational actuation timer and an axial rotation timer, the first axial rotational actuation timer is connected to a first axial rotational actuator, the first axial rotational actuator is driven by the first axial rotational actuation timer and switches an axial rotational forward and reverse switch, and the second axial rotational actuation timer is connected to a second axial rotational actuator, the second axial rotational actuator is driven by the second axial rotational actuation timer and switches the axial rotational forward and reverse switch, the axial rotational forward and reverse switch is electrically connected to the axial rotation timer and the axial rotational drive motor, the axial rotation timer energizes the axial rotational drive motor at a set time, the axial rotational drive motor rotates the axial rotational rotating disk via the axial rotational drive shaft, and the axial rotation timer stops energizing the axial rotational drive motor and stops rotating the axial rotational rotating disk at a set time.

According to one embodiment of the solar energy device for the automatically controlled sun tracking system of the invention, wherein the revolution component further comprises a revolution base, the revolution rotating disk is assembled on the revolution base, the revolution drive shaft passes through the revolution base, and an end portion of the revolution drive shaft has a revolution drive gear assembled with a revolution teeth edge of the revolution rotating disk.

According to one embodiment of the solar energy device for the automatically controlled sun tracking system of the invention, wherein the revolution component further comprises at least one revolution support bearing, the revolution support bearing is disposed on the revolution base and supports the revolution rotating disk.

According to one embodiment of the solar energy device for the automatically controlled sun tracking system of the invention, wherein the first positioning pin and the second positioning pin are disposed on the revolution rotating disk, the first positioning pin and the second positioning pin are respectively disposed on one side of the revolution rotating disk, the first touch switch and the second touch switch are disposed on the revolution base, and the first touch switch and the second touch switch are disposed between the first positioning pin and the second positioning pin.

According to one embodiment of the solar energy device for the automatically controlled sun tracking system of the invention, wherein the axial rotational component further comprises two axial rotational seat plate sets, the axial rotational seat plate sets are assembled on the revolution rotating disk, the axial rotational rotating disk is assembled on the axial rotational seat plate set, the axial rotational drive shaft passes through the axial rotational seat plate set, and an end portion of the axial rotational drive shaft has an axial rotational drive gear assembled with an axial rotational teeth edge of the axial rotational rotating disk.

According to one embodiment of the solar energy device for the automatically controlled sun tracking system of the invention, wherein the axial rotational component further comprises at least one axial rotational support bearing, the axial rotational support bearing is disposed on the axial rotational seat plate set and supports the axial rotational rotating disk.

According to one embodiment of the solar energy device for the automatically controlled sun tracking system of the invention, further comprising at least one power supply component, the power supply component being electrically connected to the revolution timer and the axial rotation timer, a revolution step-down regulator being provided between the power supply component and the revolution timer, and an axial rotational step-down regulator being provided between the power supply component and the axial rotation timer.

According to one embodiment of the solar energy device for the automatically controlled sun tracking system of the invention, wherein the power supply component is further electrically connected to the first touch switch, the second touch switch, the first axial rotational actuation timer and the second axial rotational actuation timer.

According to one embodiment of the solar energy device for the automatically controlled sun tracking system of the invention, further comprising a solar energy component, the solar energy component being assembled on the axial rotational rotating disk, the solar energy component further comprising a plurality of bottom assembling rods and a plurality of solar panels assembled with one another, the axial rotational component being further provided with a plurality of solar assembling rods and a plurality of solar assembling rod connecting plates, the solar assembling rods passing through the axial rotational rotating disks and being connected in series with the solar assembling rod connecting plates, and the solar energy component being assembled with the solar assembling rod connecting plates and the solar assembling rods through the bottom assembling rods.

According to one embodiment of the solar energy device for the automatically controlled sun tracking system of the invention, wherein the revolution rotating disk is further provided with at least one revolution calibration mark thereon, and the axial rotational rotating disk is further provided with at least one axial rotational calibration mark thereon.

### BRIEF DESCRIPTION OF THE DRAWINGS

FIG. 1 is a perspective assembled view of a solar energy device for an automatically controlled sun tracking system of the invention.

FIG. 2 is a perspective partial assembled view of the solar energy device for the automatically controlled sun tracking system of the invention.

FIG. 3 is a perspective partial assembled view of the solar energy device for the automatically controlled sun tracking system of the invention from another angle.

FIG. 4 is a block diagram of the solar energy device for the automatically controlled sun tracking system of the invention.

FIG. 5 is a perspective view of implementation of the solar energy device for the automatically controlled sun tracking system of the invention.

FIG. 6 is a block diagram of implementation of the solar energy device for the automatically controlled sun tracking system of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to a solar energy device for an automatically controlled sun tracking system of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numbers.

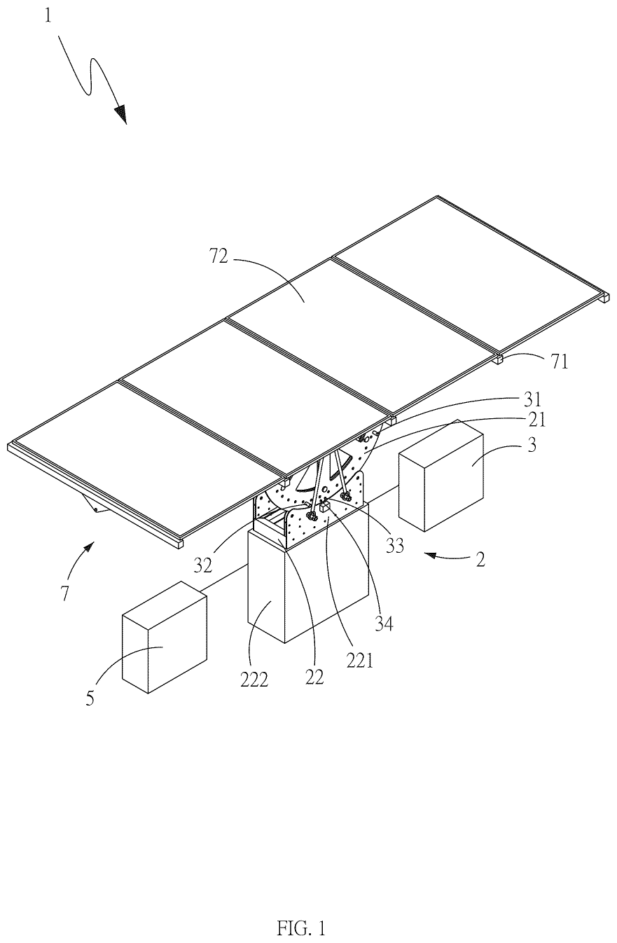

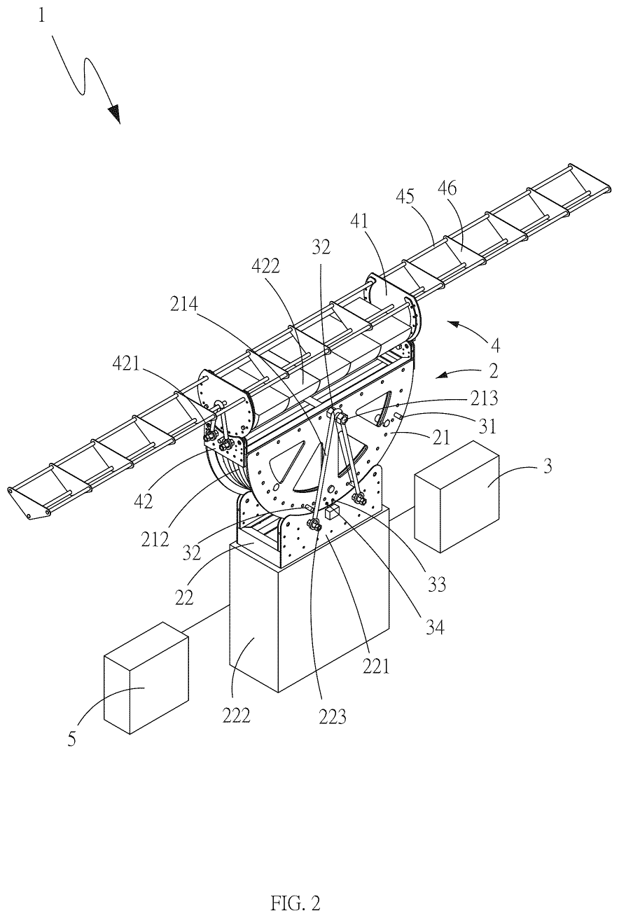

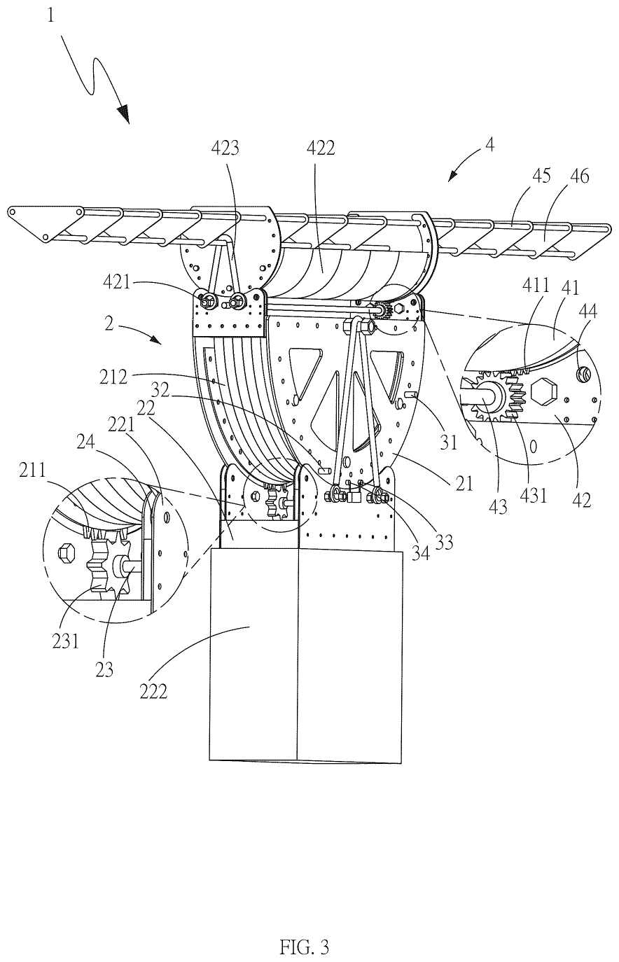

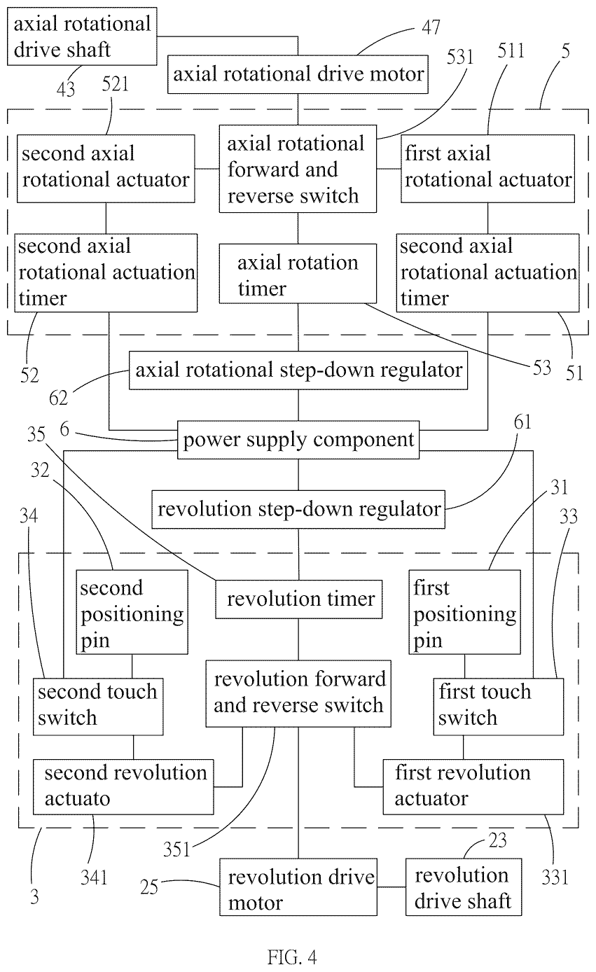

Firstly, please refer to FIGS. 1 to 4 for a perspective assembled view, a perspective partial assembled view, a perspective partial assembled view from another angle, and a block diagram of a solar energy device for an automatically controlled sun tracking system of the invention respectively. It can be clearly seen from the figures that a solar energy device for an automatically controlled sun tracking system 1 mainly comprises a revolution component 2, a revolution control component 3, an axial rotational component 4, an axial rotation control component 5, a power supply component 6, and a solar energy component 7.

Wherein the revolution component 2 comprises two revolution rotating disks 21, an outer periphery of each of the revolution rotating disks 21 is in the shape of an arc and is a semicircular plate, in order to reduce weight, each of the revolution rotating disks 21 can have appropriate hollow portions. Each of the revolution rotating disks 21 is respectively assembled on a revolution base 22, wherein the revolution base 22 is fixedly disposed at a predetermined position such as on the ground or a platform that can be exposed to the sun, a revolution seat plate set 221 is respectively disposed on two sides of the revolution base 22, the revolution seat plate set 221 in this embodiment is composed of two side plates, and a revolution seat counterweight box 222 is disposed at a bottom of the revolution base 22. The revolution seat counterweight box 222 can be a counterweight block or can be used for accommodating a battery for supplying power or can be configured with a water-filled space, and the revolution seat plate set 221 is fixedly disposed on the ground or a platform by the revolution seat counterweight box 222. In addition, at least one revolution seat limit fixing bolt 223 is disposed on a side of the revolution seat plate set 221. In this embodiment, the two revolution seat limit fixing bolts 223 are disposed on a side of the revolution seat plate set 221.

In addition, wherein each of the revolution rotating disks 21 is respectively assembled on the revolution seat plate set 221 on two sides, so that an appropriate spacing is formed between the two revolution rotating disks 21, a revolution teeth edge 211 is formed at a bottom of each of the revolution rotating disks 21, a revolution counterweight 212 is disposed in the appropriate spacing, and the revolution counterweight 212 can be a counterweight block or can be used for accommodating a battery for supplying power or can be configured with a water-filled space. The revolution component 2 is further provided with a revolution drive shaft 23, one end of the revolution drive shaft 23 is assembled with the revolution seat plate set 221 on one side, and another end of the revolution drive shaft 23 is assembled with the revolution seat plate set 221 on another side. Two end portions of the revolution drive shaft 23 are respectively provided with a revolution drive gear 231, and the revolution drive shaft 23 is assembled with the revolution teeth edge 211 through the revolution drive gear 231. In addition, the revolution component 2 is further provided with at least one revolution support bearing 24, the revolution support bearing 24 is disposed on the revolution seat plate set 221. In this embodiment, the four revolution support bearings 24 are provided and are assembled between the two side plates of the revolution seat plate set 221. The revolution drive shaft 23 is correspondingly disposed at a central position of the revolution seat plate set 221 and a bottom of the revolution rotating disk 21, the revolution support bearing 24 is correspondingly disposed on two sides of the revolution seat plate set 221 and two sides of a bottom of the revolution rotating disk 21, and the revolution support bearing 24 supports the revolution rotating disk 21. In addition, the revolution component 2 further comprises a revolution drive motor 25, the revolution drive motor 25 is connected to the revolution drive shaft 23, and at least one reducer (not shown in the figures) can be disposed between the revolution drive motor 25 and the revolution drive shaft 23 to control a rotation speed of the revolution drive shaft 23.

In addition, wherein at least one rotating disk limiting rotation axis 213 and a revolution limiting ring rope 214 are disposed on a side of the revolution rotating disk 21. The revolution limiting ring rope 214 is a rope with elasticity and rings, two ends of the revolution limiting ring rope 214 are sleeved on the revolution seat limit fixing bolts 223, and a middle section of the revolution limiting ring rope 214 is wound around the rotating disk limiting rotation axis 213, so that the revolution component 2 is fixed at a predetermined position on the revolution base 22, and the revolution component 2 can be limited by the rings and is enabled for performing rotation conveniently while rotating.

Wherein the revolution control component 3 is provided with a first positioning pin 31, a second positioning pin 32, a first touch switch 33, a second touch switch 34 and a revolution timer 35. In this embodiment, the first positioning pin 31 and the second positioning pin 32 are disposed on the revolution rotating disk 21, and the first positioning pin 31 and the second positioning pin 32 are disposed on two sides of the revolution rotating disk 21 respectively. An included angle between the first positioning pin 31 and the second positioning pin 32 with an axis as a center of a circle is 47 degrees in this embodiment. The first touch switch 33 and the second touch switch 34 are disposed on the revolution base 22. In this embodiment, the first touch switch 33 and the second touch switch 34 are disposed on a mounting platform of the revolution base 22. The first touch switch 33 and the second touch switch 34 are disposed between the first positioning pin 31 and the second positioning pin 32, the first touch switch 33 and the second touch switch 34 are electrically connected to the power supply component 6, the first touch switch 33 is electrically connected to a first revolution actuator 331, and the second touch switch 34 is electrically connected to a second revolution actuator 341. The revolution timer 35 is electrically connected to the power supply component 6 and a revolution forward and reverse switch 351, the revolution timer 35 is electrically connected to the revolution drive motor 25 through the revolution forward and reverse switch 351, and a revolution step-down regulator 61 is disposed between the power supply component 6 and the revolution timer 35.

Wherein the axial rotational component 4 comprises two axial rotational rotating disks 41 and two axial rotational seat plate sets 42. The two axial rotational seat plate sets 42 are assembled on the revolution rotating disk 21. In this embodiment, each of the two axial rotational seat plate sets 42 is composed of two side plates, and two side limit fixing bolts 421 are disposed on a side of the axial rotational seat plate set 42. Each of the axial rotational rotating disks 41 is respectively assembled on the axial rotational seat plate set 42 on two sides, so that an appropriate spacing is formed between the two axial rotational rotating disks 41, and an axial rotational teeth edge 411 is formed at a bottom of each of the axial rotational rotating disks 41. An axial rotational counterweight 422 is disposed in the appropriate spacing, and the axial rotational counterweight 422 can be a counterweight block or can be used for accommodating a battery for supplying power or can be configured with a water-filled space. In addition, the axial rotational component 4 is further provided with an axial rotational drive shaft 43, one end of the axial rotational drive shaft 43 is assembled with one of the axial rotational seat plate sets 42 on one side, and another end of the axial rotational drive shaft 43 is assembled with the other axial rotational seat plate set 42 on another side. Two end portions of the axial rotational drive shaft 43 are respectively provided with an axial rotational drive gear 431, and the axial rotational drive shaft 43 is assembled with the axial rotational teeth edge 411 through the axial rotational drive gear 431. The axial rotational component 4 is further provided with at least one axial rotational support bearing 44, and the axial rotational support bearing 44 is disposed on the axial rotational seat plate set 42. In this embodiment, the four axial rotational support bearings 44 are provided and are assembled between the two side plates of the axial rotational seat plate set 42, the axial rotational drive shaft 43 is correspondingly disposed at a central position of the axial rotational seat plate set 42 and a bottom of the axial rotational rotating disks 41, the axial rotational support bearing 44 is correspondingly disposed on two sides of the axial rotational seat plate set 42 and two sides of a bottom of the axial rotational rotating disk 41, and the axial rotational support bearing 44 supports the axial rotational rotating disk 41. The axial rotational component 4 further comprises a plurality of solar assembling rods 45 and a plurality of solar assembling rod connecting plates 46. The solar assembling rods 45 pass through the axial rotational rotating disks 41 and are connected in series with the solar assembling rod connecting plates 46. The axial rotational component 4 further comprises an axial rotational drive motor 47. The axial rotational drive motor 47 is connected to the axial rotational drive shaft 43, and at least one reducer (not shown in the figures) can be disposed between the axial rotational drive motor 47 and the axial rotational drive shaft 43 to control a rotation speed of the axial rotational drive shaft 43.

In addition, wherein the axial rotational component 4 is provided with an axial rotational limiting ring rope 423 at positions of the side limit fixing bolts 421. The axial rotational limiting ring rope 423 is a rope with elasticity and rings, two ends of the axial rotational limiting ring rope 423 are sleeved on the side limit fixing bolts 421, and a middle section of the axial rotational limiting ring rope 423 is wound around the solar assembling rod 45, so that the axial rotational component 4 is fixed at a predetermined position on the revolution component 2, and the axial rotational component 4 can be limited by the rings and is enabled for performing rotation conveniently while rotating.

Wherein the axial rotation control component 5 is provided with a first axial rotational actuation timer 51, a second axial rotational actuation timer 52 and an axial rotation timer 53. The first axial rotational actuation timer 51 is connected to a first axial rotational actuator 511, and the second axial rotational actuation timer 52 is connected to a second axial rotational actuator 521. The first axial rotational actuation timer 51 and the second axial rotational actuation timer 52 are electrically connected to the power supply component 6. In addition, the axial rotation timer 53 is electrically connected to the power supply component 6 and an axial rotational forward and reverse switch 531, the axial rotation timer 53 is electrically connected to the axial rotational drive motor 47 through the axial rotational forward and reverse switch 531, and an axial rotational step-down regulator 62 is provided between the power supply component 6 and the axial rotation timer 53.

Wherein the solar energy component 7 is assembled on the axial rotational rotating disks 41, the solar energy component 7 further comprises a plurality of bottom assembling rods 71 and a plurality of solar panels 72 assembled with one another, and the solar energy component 7 is assembled with the solar assembling rod connecting plates 46 and the solar assembling rods 45 through the bottom assembling rods 71. The solar assembling rods 45 pass through the axial rotational rotating disks 41 and are connected in series with the solar assembling rod connecting plates 46.

In addition, each component in the solar energy device for the automatically controlled sun tracking system 1 of the invention is preferably made of metal material to have appropriate rigidity to support, for example, solar-related components disposed thereon, depending on different required rigidities, some components can be made of materials such as aluminum, and some components can be made of materials such as steel.

In addition, the solar energy device for the automatically controlled sun tracking system 1 of the invention can further comprise a rain detection unit and a wind speed detection unit (not shown in the figures). Wherein the rain detection unit can adjust an angle of a solar component when it rains. For example, when the solar energy component 7 is a condensation panel or a solar panel 72, its area and angle can be utilized to achieve an object of collecting rainwater. Wherein the wind speed detection unit can adjust an angle of the solar energy component 7 when a wind speed is too high, thereby reducing structures from bearing too much wind force to avoid problems such as damage. In addition, a cleaning water spray pipeline device can be installed around the solar energy device for the automatically controlled sun tracking system 1 or the solar energy component 7 for users to wash regularly and keep it clean and maintain light collection efficiency.

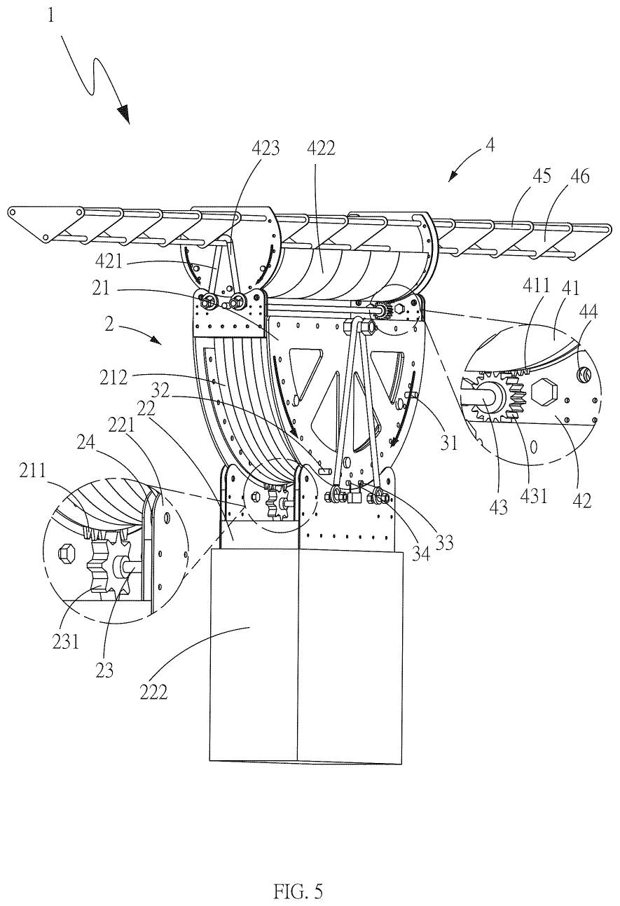

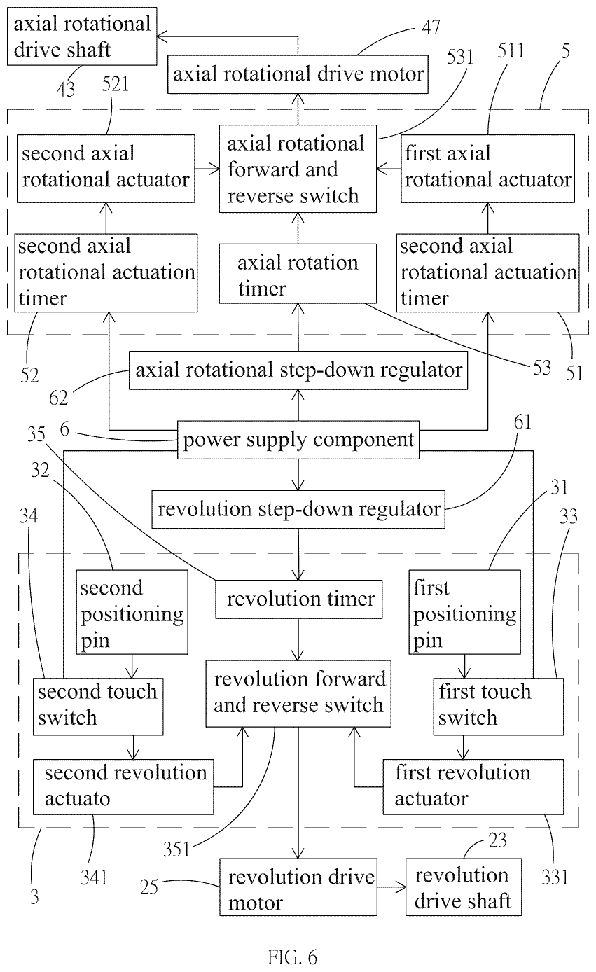

Please refer to the aforementioned drawings and FIGS. 5 and 6 for a perspective view of implementation and a block diagram of implementation of the solar energy device for the automatically controlled sun tracking system of the invention respectively. Wherein after the solar energy device for the automatically controlled sun tracking system 1 is fixedly disposed at a predetermined position such as on the ground or on a platform that can be exposed to the sun, and a voltage of the power supply component 6 is stepped down by the revolution step-down regulator 61. In this embodiment, the power supply component 6 provides a 12V voltage, which is then reduced to 5V by the revolution step-down regulator 61 and provided to the revolution timer 35. The revolution timer 35 can provide the received 5V voltage to the revolution forward and reverse switch 351 according to a set time. The revolution forward and reverse switch 351 starts the revolution drive motor 25, and its set time is mainly determined according to a rotation speed of the earth's revolution. In this embodiment, the revolution timer 35 is set to start energizing the revolution forward and reverse switch 351 at 10:00 every day, and stop energizing at 10:10 on a same day. In this embodiment, the revolution forward and reverse switch 351 has been switched to a CW position by the first revolution actuator 331. Therefore, when the revolution forward and reverse switch 351 starts the revolution drive motor 25, the revolution drive motor 25 drives the revolution drive shaft 23 and the revolution drive gear 231. When the revolution drive gear 231 rotates, the revolution teeth edge 211 of the revolution rotating disk 21 can be driven by meshing, so that the revolution rotating disk 21 rotates on the revolution base 22. While the revolution rotating disk 21 rotates on the revolution base 22, the revolution support bearings 24 are attached to two sides of a bottom of the revolution rotating disk 21. The revolution support bearings 24 assist the revolution rotating disk 21 in rotating, and the solar energy component 7 on the axial rotational component 4 also changes its angle accordingly.

When the revolution timer 35 starts the revolution drive motor 25 for 10 minutes every day, the revolution drive motor 25 works for 182.5 days, and the revolution rotating disk 21 rotates 47 degrees. At this time, the second positioning pin 32 touches the second touch switch 34, and the second touch switch 34 transmits a 12V voltage of the power supply component 6 to the second revolution actuator 341, and the second revolution actuator 341 is electromagnetically actuated and hits the revolution forward and reverse switch 351 to switch the revolution forward and reverse switch 351 to CCW. The revolution timer 35 also starts to energize the revolution forward and reverse switch 351 at 10:00 a.m. every day, and stops energizing at 10:10 a.m. on a same day, so that the revolution drive motor 25 drives the revolution drive shaft 23 and the revolution drive gear 231. When the revolution drive gear 231 rotates, the revolution teeth edge 211 of the revolution rotating disk 21 can be driven by meshing, so that the revolution rotating disk 21 rotates on the revolution base 22, and the revolution timer 35 starts the revolution drive motor 25 for 10 minutes every day. After the revolution drive motor 25 works for 182.5 days, the revolution rotating disk 21 rotates 47 degrees. At this time, the first positioning pin 31 touches the first touch switch 33, and the first touch switch 33 transmits a 12V voltage of the power supply component 6 to the first revolution actuator 331, and the first revolution actuator 331 is electromagnetically actuated and hits the revolution forward and reverse switch 351, so that the revolution forward and reverse switch 351 switches to CW, and so on. The solar energy device for the automatically controlled sun tracking system 1 is capable of automatically controlling the revolution component 2 and the solar energy component 7 to revolve and track the sun through the revolution control component 3, which can save setup costs of a conventional control chip that needs to use complex software programming to track the sun to achieve an efficacy of reducing production and maintenance costs.

In addition, wherein after the solar energy device for the automatically controlled sun tracking system 1 is fixedly disposed at a predetermined position such as on the ground or on a platform that can be exposed to the sun, a voltage of the power supply component 6 is stepped down through the axial rotational step-down regulator 62. In this embodiment, the power supply component 6 provides a 12V voltage, which is then stepped down to 5V by the axial rotational step-down regulator 62 and provided to the axial rotation timer 53. The axial rotation timer 53 can provide the received 5V voltage to the axial rotational forward and reverse switch 531 according to a set time. The axial rotational forward and reverse switch 531 starts the axial rotational drive motor 47, and its set time is mainly determined according to a rotation speed of the earth's rotation. In this embodiment, the axial rotation timer 53 is set to start energizing the axial rotational forward and reverse switch 531 at 07:03 every day, stop energizing at 16:58, start energizing the axial rotational forward and reverse switch 531 at 17:03, stop energizing at 21:58, start energizing the axial rotational forward and reverse switch 531 at 01:58, and stop energizing at 06:58. In this embodiment, the axial rotational forward and reverse switch 531 has been switched to the CW position by the second axial rotational actuator 521. Therefore, when the axial rotational forward and reverse switch 531 starts the axial rotational drive motor 47, the axial rotational drive motor 47 drives the axial rotational drive shaft 43 and the axial rotational drive gear 431. When the axial rotational drive gear 431 rotates, the axial rotational teeth edge 411 of the axial rotational rotating disk 41 can be driven by meshing, so that the axial rotational rotating disk 41 rotates on the axial rotational seat plate set 42. While the axial rotational rotating disk 41 rotates on the axial rotational seat plate set 42, the axial rotational support bearings 44 are attached to two sides of a bottom of the axial rotational rotating disk 41. The axial rotational support bearings 44 assist rotation of the axial rotational rotating disks 41, and an angle of the solar energy component 7 on the axial rotational component 4 also changes accordingly.

In this embodiment, the first axial rotational actuation timer 51 is set to start energizing the first axial rotational actuator 511 at 7:00 a.m. every day, and stop energizing at 7:01 a.m. on a same day. The second axial rotational actuation timer 52 is set to start energizing the second axial rotational actuator 521 at 17:00 p.m. every day, and stop energizing at 17:01 p.m. on a same day. Therefore, when the second axial rotational actuation timer 52 reaches 17:00 p.m., the second axial rotational actuation timer 52 starts energizing the second axial rotational actuator 521, and the second axial rotational actuator 521 is electromagnetically actuated and hits the axial rotational forward and reverse switch 531, so that the axial rotational forward and reverse switch 531 is switched to CCW. Then, when the axial rotation timer 53 reaches a set time, the axial rotational forward and reverse switch 531 starts energizing the axial rotational drive motor 47, and the axial rotational drive motor 47 drives the axial rotational drive shaft 43 and the axial rotational drive gear 431. When the axial rotational drive gear 431 rotates, the axial rotational teeth edge 411 of the axial rotational rotating disk 41 can be driven by meshing, so that the axial rotational rotating disk 41 rotates on the axial rotational seat plate set 42, and so on. When the first axial rotational actuation timer 51 is at 7:00, the first axial rotational actuation timer 51 starts energizing the first axial rotational actuator 511, and the first axial rotational actuator 511 is electromagnetically actuated and hits the axial rotational forward and reverse switch 531, so that the axial rotational forward and reverse switch 531 is switched to CW. The solar energy device for the automatically controlled sun tracking system 1 is capable of automatically controlling the axial rotational component 4 and the solar energy component 7 to revolve and track the sun through the axial rotation control component 5, which can save setup costs of a conventional control chip that needs to use complex software programming to track the sun to achieve an efficacy of reducing production and maintenance costs.

In addition, wherein during a regular time schedule in 24 hours every day, the axial rotation timer 53 is set to start energizing the axial rotational forward and reverse switch 531 at 07:03 every day and stop energizing at 16:58, start energizing the axial rotational forward and reverse switch 531 at 17:03 and stop energizing at 21:58, and start energizing the axial rotational forward and reverse switch 531 at 01:58 and stop energizing at 06:58, the solar energy device for the automatically controlled sun tracking system 1 rotates and tracks the sun for 9 hours and 55 minutes, and in the remaining 14 hours and 5 minutes, the axial rotational drive motor 47 is required to reverse and take rest. Therefore, the first axial rotational actuator 511 is actuated at 7:00 and switches the axial rotational forward and reverse switch 531 to the CCW position, and the axial rotational drive motor 47 is powered on to operate from 07:03 to 16:58 according to a time interval set by the axial rotation timer 53, so that the axial rotational drive motor 47 is powered on for 9 hours and 55 minutes. The time setting of 16:58 is to enable the axial rotational drive motor 47 to have a stop time to avoid damage caused by instantaneous forward and reverse rotation. Then, the second axial rotational actuator 521 is actuated at 17:00 and switches the axial rotational forward and reverse switch 531 to the CW position, and the axial rotational drive motor 47 is powered on to operate from 17:03 to 21:58 according to a setting time of the axial rotation timer 53, so that the axial rotational drive motor 47 is energized for 4 hours and 55 minutes, and then the axial rotational drive motor 47 stops operating for 4 hours until a setting time of the axial rotation timer 53 reaches 01:58. The axial rotational drive motor 47 is powered on to operate from 01:58 to 06:58 according to a setting time of the axial rotation timer 53. The time setting of 06:58 is to enable the axial rotational drive motor 47 to have a stop time to avoid damage caused by instantaneous forward and reverse rotation. At this time, the axial rotational rotating disk 41 also reverses to a forward rotation starting position, and then the axial rotational drive motor 47 is powered on to operate from 07:03 to 16:58 according to a setting time of the axial rotation timer 53, so that the axial rotational drive motor 47 is powered on for 9 hours and 55 minutes, and so on. The solar energy device for the automatically controlled sun tracking system 1 is capable of automatically controlling the axial rotational component 4 and the solar energy component 7 to revolve and track the sun through the axial rotation control component 5, which can save setup costs of a conventional control chip that needs to use complex software programming to track the sun to achieve an efficacy of reducing production and maintenance costs.

In addition, wherein the power supply component 6 can be charged externally or by solar energy, and the revolution control component 3 and the axial rotation control component 5 can be disposed in a control box. In addition, a revolution calibration mark can be disposed on the revolution rotating disk 21. The revolution calibration mark is a sticker scaled with dates of a full year. A position of a day indicated by the scale is an inclination of the sun's revolution, so that the revolution rotating disk 21 is set or controlled to rotate according to dates. In addition, an axial rotational calibration mark is further disposed on the axial rotational rotating disk 41. The axial rotational calibration mark is a sticker scaled with time. A position of a current time indicated by the scale is a rotation angle of the earth.

The invention has been described in detail above, but the above description merely illustrates a preferred embodiment of the invention, and should not be used to limit a scope implemented by the invention, that is, all equivalent changes and modifications made according to the applied scope of the invention should still fall within the scope covered by the appended claims of the invention.

What is claimed is:

1. A solar energy device for an automatically controlled sun tracking system, comprising:
a revolution component, the revolution component being provided with two revolution rotating disks, a revolution drive shaft and a revolution drive motor, the revolution drive shaft being assembled with the revolution rotating disks and connected to the revolution drive motor;
a revolution control component, the revolution control component being provided with a first positioning pin, a second positioning pin, a first touch switch, a second touch switch and a revolution timer, the first touch switch being connected to a first revolution actuator, the first revolution actuator being driven by the first positioning pin contacting the first touch switch and switching a revolution forward and reverse switch, and the second touch switch being connected to a second revolution actuator, the second revolution actuator being driven by the second positioning pin contacting the second touch switch and switching the revolution forward and reverse switch, the revolution forward and reverse switch being electrically connected to the revolution timer and the revolution drive motor, the revolution timer energizing the revolution drive motor at a set time, the revolution drive motor rotating the revolution rotating disks via the revolution drive shaft, and the revolution timer stopping energizing the revolution drive motor and stopping rotating the revolution rotating disks at a set time;
an axial rotational component, the axial rotational component being disposed on the revolution component, and the axial rotational component being provided with two axial rotational rotating disks, an axial rotational drive shaft and an axial rotational drive motor, the axial rotational drive shaft being assembled with the axial rotational rotating disk and connected to the axial rotational drive motor; and
an axial rotation control component, the axial rotation control component being provided with a first axial rotational actuation timer, a second axial rotational actuation timer and an axial rotation timer, the first axial rotational actuation timer being connected to a first axial rotational actuator, the first axial rotational actuator being driven by the first axial rotational actuation timer and switching an axial rotational forward and reverse switch, and the second axial rotational actuation timer being connected to a second axial rotational actuator, the second axial rotational actuator being driven by the second axial rotational actuation timer and switching the axial rotational forward and reverse switch, the axial rotational forward and reverse switch being electrically connected to the axial rotation timer and the axial rotational drive motor, the axial rotation timer energizing the axial rotational drive motor at a set time, the axial rotational drive motor rotating the axial rotational rotating disk via the axial rotational drive shaft, and the axial rotation timer stopping energizing the axial rotational drive motor and stopping rotating the axial rotational rotating disk at a set time.

2. The solar energy device for the automatically controlled sun tracking system as claimed in claim 1, wherein the revolution component further comprises a revolution base, the revolution rotating disk is assembled on the revolution base, the revolution drive shaft passes through the revolution base, and an end portion of the revolution drive shaft has a revolution drive gear assembled with a revolution teeth edge of the revolution rotating disk.

3. The solar energy device for the automatically controlled sun tracking system as claimed in claim 2, wherein the revolution component further comprises at least one revolution support bearing, the revolution support bearing is disposed on the revolution base and supports the revolution rotating disk.

4. The solar energy device for the automatically controlled sun tracking system as claimed in claim 3, wherein the first positioning pin and the second positioning pin are disposed on the revolution rotating disk, the first positioning pin and the second positioning pin are respectively disposed on one side of the revolution rotating disk, the first touch switch and the second touch switch are disposed on the revolution base, and the first touch switch and the second touch switch are disposed between the first positioning pin and the second positioning pin.

5. The solar energy device for the automatically controlled sun tracking system as claimed in claim 1, wherein the axial rotational component further comprises two axial rotational seat plate sets, the axial rotational seat plate sets are assembled on the revolution rotating disk, the axial rotational rotating disk is assembled on the axial rotational seat plate set, the axial rotational drive shaft passes through the axial rotational seat plate set, and an end portion of the axial rotational drive shaft has an axial rotational drive gear assembled with an axial rotational teeth edge of the axial rotational rotating disk.

6. The solar energy device for the automatically controlled sun tracking system as claimed in claim 5, wherein the axial rotational component further comprises at least one axial rotational support bearing, the axial rotational support bearing is disposed on the axial rotational seat plate set and supports the axial rotational rotating disk.

7. The solar energy device for the automatically controlled sun tracking system as claimed in claim 1, further comprising at least one power supply component, the power supply component being electrically connected to the revolution timer and the axial rotation timer, a revolution step-down regulator being provided between the power supply component and the revolution timer, and an axial rotational step-down regulator being provided between the power supply component and the axial rotation timer.

8. The solar energy device for the automatically controlled sun tracking system as claimed in claim 7, wherein the power supply component is further electrically connected to the first touch switch, the second touch switch, the first axial rotational actuation timer and the second axial rotational actuation timer.

9. The solar energy device for the automatically controlled sun tracking system as claimed in claim 3, further comprising a solar energy component, the solar energy component being assembled on the axial rotational rotating disk, the solar energy component further comprising a plurality of bottom assembling rods and a plurality of solar panels assembled with one another, the axial rotational component being further provided with a plurality of solar assembling rods and a plurality of solar assembling rod connecting plates, the solar assembling rods passing through the axial rotational rotating disks and being connected in series with the solar assembling rod connecting plates, and the solar energy component being assembled with the solar assembling rod connecting plates and the solar assembling rods through the bottom assembling rods.

10. The solar energy device for the automatically controlled sun tracking system as claimed in claim 1, wherein the revolution rotating disk is further provided with at least one revolution calibration mark thereon, and the axial rotational rotating disk is further provided with at least one axial rotational calibration mark thereon.
